(19) United States
(12) Patent Application Publication
(10) Pub. No.: US 2003/0044501 A1
(43) Pub. Date: Mar. 6, 2003

(54) Method of portioning frozen food

(75) Inventor: Petra Groneberg-Nienstedt, Dusseldorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: NIENSTEDT GMBH

(21) Appl. No.: 10/228,249

(22) Filed: Aug. 26, 2002

(30) Foreign Application Priority Data
Aug. 28, 2001 (DE) 10141989.9

(51) Int. Cl. A01J 1/00

(52) U.S. Cl. 426/513

(57) ABSTRACT

A food product is portioned without having to saw through deep frozen bodies by forming a flat slab or plate of the nonfrozen food product and then cooling the product to a temperature at which it is stampable, e.g. −1° C. to −10° C. The slab is then stamped by a stamping grid on a ram or roll to form the individual portions which can then be deep frozen and may be breaded prior to being deep frozen.

### FIELD OF THE INVENTION

My present invention relates to a method of portioning frozen food products or comestibles and, in particular the portioning of pieces of meat, fish and/or vegetables.

### BACKGROUND OF THE INVENTION

It is known for example, to deep freeze fish fillets immediately after the catch to form large blocks of fish which are then cut up by saws. The blocks are sawn into slices, the slices are sawn into strips and then the strips are sawn transversely into the individual portions (see German Patent 43 34 107). In the method of German open application 2 347 280, deep frozen slabs which may be produced by sawing up a deep frozen block, can be subject to stamping out of individual portions. In both cases the production of large blocks of deep frozen food products is necessary and such deep frozen blocks must be subdivided in the deep frozen state.

### OBJECTS OF THE INVENTION

It is the principal object of the present invention to provide a method of or process for the portioning of food products so that the preparation of large blocks of a deep-frozen product is not required.

More specifically it is an object of this invention to provide a method of producing food portions with the long-term storage stability of deep-frozen products but which eliminates the need for producing initial deep-frozen blocks which must be subdivided by sawing.

Yet another object of this invention is to provide a method for the purposes described, whereby the losses due to sawing and the production of a kerf in a deep-frozen product are eliminated.

### SUMMARY OF THE INVENTION

These objects and others which will become apparent hereinafter are attained, in accordance with the invention in a process whereby the food product in a nonfrozen state or in a frozen state but one in which the food product has been frozen at a temperature well above the deep-frozen temperature for the food or during a period of time less than that required for full deep freezing of the product, in the form of a flat plate or slab or a plate- or slab-shaped strand are undercooled, i.e. cooled to a still lower temperature, in which the food product is stampable. The food product is then stamped with a stamping grid or a roller having a stamping grid on its surface to subdivide it into discrete portions.

While the temperatures at which the product is deemed to be “stampable” in the sense mentioned above are given below, as a general matter the food product is deemed to be stampable when a blade formation can be pressed into the product and can cut it without distortion on either side of the blade and without tearing the product or causing losses thereof. The term “blade” is used herein loosely to mean the ribs, vanes or partitions between the cells of the stamping grid on a ramp operating as a punch or on the roller formed with a stamping grid. Each portion has the shape and external dimensions of the internal dimensions of the respective cell of the grid.

By contrast with earlier processes, the food product is not deep frozen prior to portioning and thus there is no need to handle or produce large deep-frozen blocks of the food product to be portioned. There is thus also no need to cut plates or slabs of the food product by a sawing process.

Rather, before deep freezing, the food product mass is processed so that it is only minimally cooled and in any event to a temperature or for a duration which will cool the product without deep freezing it. This mass is then cooled down further only to the extent required to make it stampable in the sense described above so that the stamped out individual portions are shape-retentive.

By eliminating the large deep-frozen blocks hitherto required, the process is greatly simplified, the time for producing individual portions is greatly reduced and losses are avoided, especially since the sawing residues are eliminated.

According to a feature of the invention, during or after stamping, the portions are shaped by pressing. As a result, the individual portions need not have the sharp edges of cubes, for example, but can have rounded edges which are more appetizing as individual portions of a food product for eating.

The temperature of the product during stamping may range from +1° C. to −10° C., especially +2° C. to −6° C.

It has been found to be advantageous to provide the slab or flat product which is stamped with a thickness of 10 to 40 mm, especially 15 to 20 mm. As a general matter the stamped product may be more or less cubical with an edge length which (for instance) does not exceed 200 mm.

So that the individual portions after stamping do not adhere together, the portions are separated after stamping in accordance with a feature of the invention. It is further advantageous to subject the portions after stamping to deep freezing, thereby facilitating transport and storage of the product.

It has also been found to be advantageous to subject the portions after stamping to breading, i.e. coating with bread crumbs, flour, mixtures of flour and breading products and egg, etc. Thus the portions after stamping can be coated with egg and bread crumbs.

The method of the invention is applicable to the meat of fowl and fish as well as to vegetables.

### BRIEF DESCRIPTION OF THE DRAWING

The above and other objects, features, and advantages will become more readily apparent from the following description, reference being made to the accompanying drawing in which:

FIG. 1 is a flow diagram illustrating the method of the invention;

FIG. 2 is a plan view of a stamping die for portioning the food product;

FIG. 3 is a perspective view of a part of this die; and

FIG. 4 is a perspective view of part of a stamping roller for use in portioning.

### SPECIFIC DESCRIPTION

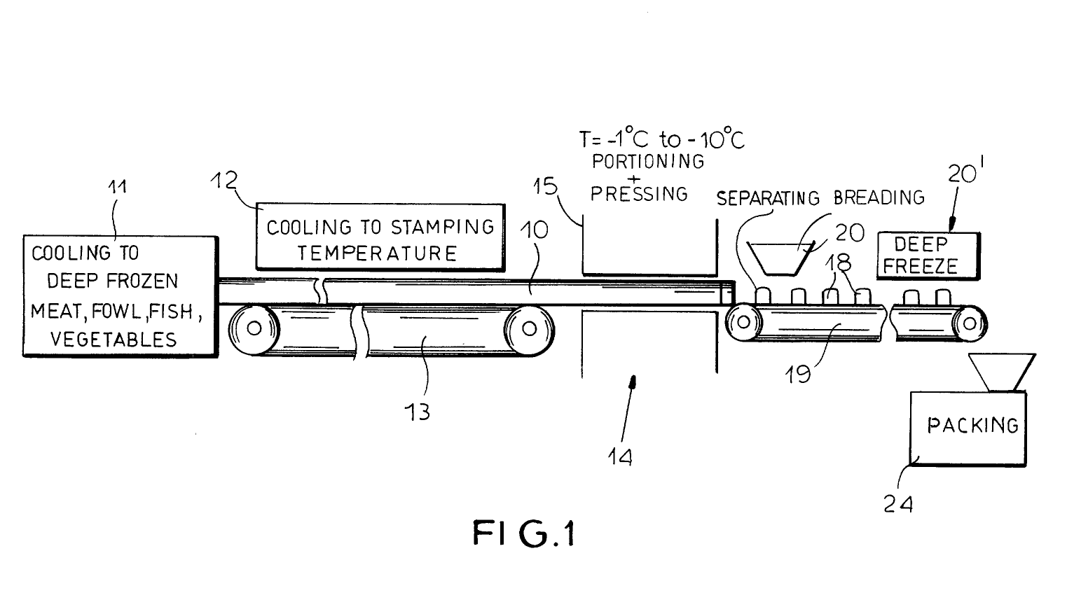

As shown in FIG. 1, the food product which can be made, especially fowl, fish or vegetables or mixtures thereof, for example, food products made from blends of fish, fowl, meat and vegetables, etc., is formed into a slab 10 which can be continuous as produced, for example, by extrusion and is of a thickness of say 15 to 20 mm. That slab is formed previously or in a stage 11 in which the meat product is cooled to a temperature which is less than a deep-freezing temperature, and at which the slab, while coherent, may still be comparatively soft. A standard refrigeration temperature below, say 4°, may suffice for this purpose, although the slab may be cooled to freezing (0° C.) if desired.

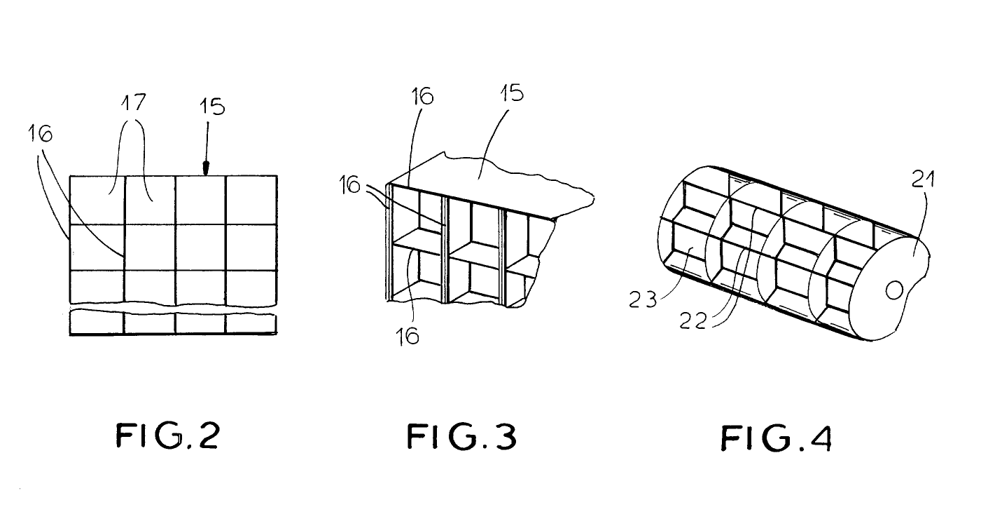

In any case, the temperature to which the slab is cooled can be well above a deep-freezing temperature. According to the invention, the slab then cooled to a lower temperature, say −1° to −10° C., e.g. on a conveyer 13, the latter temperature being referred to as a stamping temperature since the food product can be portioned by a ram or roll without damage to the structure of the portions and the meat. The portioning and pressing and stamping station has been represented at 14 in FIG. 1 and can use a ram 15 which, as can be seen in FIGS. 2 and 3, can be formed as a stamping grid with vanes 16 forming blades which define cells 17 between them. The cells may have generally the shape of squares with an edge length of say 15 to 20 mm and in any event, no greater than 200 mm so that substantially cubic portions 18 are formed. A vaned conveyor 19 may carry these portions away from the portioning station. In that station 14, the portions may be pressed and shaped. The portions 18 (pressed and/or shaped) are separated by the conveyor 19 and are breaded, i.e. coated with a breading material and, if desired, by egg which may act as a binder and dispensed at 10. The portions are then subjected to deep freezing at 20 and after being deep frozen, can be packed at 24. Instead of a ram or press for stamping out the portions, a roller 21 may be used which has vanes 22 defining the portioning cells 23.

In an example of the method of the invention, deformable food products such as fish, meat, chicken, pork or duck meat or vegetables or combinations thereof is formed in a nonfrozen state or in the slightly frozen state into the flat plate or continuous slab as illustrated in FIG. 1. The food product can be formed into the slab or the plate by extrusion.

As has been mentioned, the product is then cooled further until the food product is stampable. The temperature in this stage is between −1° C. to −10° C., but is preferably −2° C. to −6° C. At this temperature the slab is subdivided into the portions without sawing or similar loss of the food product.

The slab or flat food product can have a thickness of 10 mm to 40 mm prior to portioning, but preferably, of a thickness of 15 mm to 20 mm and the portions are preferably cuboids with an edge length no greater than 200 mm.

As noted, the portions are separated to prevent them from sticking together, are deep frozen and can be breaded if desired before being deep frozen.

When the portions are pressed on portioning or after stamping by pressing, the edges and corners can be rounded. The cells for portioning the product can, if desired, be suitably shaped to achieve a rounding.

I claim:

1. A method of portioning a food product comprising the steps of:
(a) forming a flat slab of a food product in a cooled or frozen but not deep-frozen state;
(b) cooling down said flat slab to a temperature in which the cooled down flat slab is stampable; and
(c) subdividing the cooled-down flat slab into a multiplicity of discrete portions by stamping said portions out of the cooled-down flat slab with a stamping grid punch or roll.

2. The method defined in claim 1 wherein said flat slab of a food product is formed from at least one food product selected from the group which consists of meat, fish and vegetables.

3. The method defined in claim 2 wherein said portions are shaped simultaneously with the stamping of said portions from the cooled-down slab.

4. The method defined in claim 2 wherein said portions are shaped after they have been stamped from the cooled-down slab.

5. The method defined in claim 2 wherein the cooled-down slab is brought to a temperature of −1° C. to −10° C. for stamping of said portions from said cooled-down slab.

6. The method defined in claim 5 wherein the cooled-down slab is brought to a temperature of −2° C. to −6° C. for stamping of said portions from said cooled-down slab.

7. The method defined in claim 6 wherein said cooled-down slab has a thickness of 10 to 40 mm upon stamping of said portions from said cooled-down slab.

8. The method defined in claim 7 wherein said cooled-down slab has a thickness of 15 to 20 mm upon stamping of said portions from said cooled-down slab.

9. The method defined in claim 8 wherein said portions are stamped out with a generally cuboid shape and an edge length up to 200 mm.

10. The method defined in claim 9, further comprising the step of separating said portions following stamping of said portions from said cooled-down slab.

11. The method defined in claim 10, further comprising deep freezing the portions following separating of said portions.

12. The method defined in claim 11, further comprising the step of breading the portions.

13. The method defined in claim 12 wherein said meat is fowl meat.

14. The method defined in claim 2 wherein said cooled-down slab has a thickness of 10 to 40 mm upon stamping of said portions from said cooled-down slab.

15. The method defined in claim 14 wherein said cooled-down slab has a thickness of 15 to 20 mm upon stamping of said portions from said cooled-down slab.

16. The method defined in claim 2 wherein said portions are stamped out with a generally cubic shape and an edge length up to 200 mm.

17. The method defined in claim 2, further comprising the step of separating said portions following stamping of said portions from said cooled-down slab.

18. The method defined in claim 2, further comprising deep freezing the portions following stamping of said portions from said cooled-down slab.

19. The method defined in claim 2, further comprising the step of breading the portions.

20. The method defined in claim 2 wherein said slab is a continuous strand.
